(19) United States
(12) Patent Application Publication
(10) Pub. No.: US 2021/0400949 A1
(43) Pub. Date: Dec. 30, 2021

(54) Nuisance Animal Trapping Assembly

(71) Applicant: Damon Hester, Jamaica, NY (US)

(72) Inventor: Damon Hester, Jamaica, NY (US)

(21) Appl. No.: 16/916,766

(22) Filed: Jun. 30, 2020

(51) Int. Cl. A01M 23/18; A01M 23/02

(52) U.S. Cl. CPC A01M 23/18; A01M 23/02

(57) ABSTRACT

A nuisance animal trapping assembly for controlling a population of nuisance animals includes a box, which defines an interior space. The box has a top, which is open. A lid is hingedly engaged to the box and is positioned to selectively close the top. The box has a hole positioned in a side thereof proximate to a bottom thereof. A closure is engaged to the box proximate to the hole and selectively closes the hole. A bait station is selectively positionable in the interior space and attracts a nuisance animal through the hole into the interior space. The closure retains the nuisance animal within the interior space to trap the nuisance animal.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to trapping assemblies and more particularly pertains to a new trapping assembly for controlling a population of nuisance animals.

### (2) Description of Related Art Including Information Disclosed Under 37 CFR 1.97 and 1.98

The prior art relates to trapping assemblies. Prior art trapping assemblies may comprise one-way tubes and bait.

### BRIEF SUMMARY OF THE INVENTION

An embodiment of the disclosure meets the needs presented above by generally comprising a box, which defines an interior space. The box has a top, which is open. A lid is hingedly engaged to the box and is positioned to selectively close the top. The box has a hole positioned in a side thereof proximate to a bottom thereof. A closure is engaged to the box proximate to the hole and is configured to selectively close the hole. A bait station is selectively positionable in the interior space and is configured to attract a nuisance animal through the hole into the interior space. The closure is configured to retain the nuisance animal within the interior space to trap the nuisance animal.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a nuisance animal trapping assembly according to an embodiment of the disclosure.

FIG. 2 is a side view of an embodiment of the disclosure.

FIG. 3 is a front view of an embodiment of the disclosure.

FIG. 4 is a cross-sectional view of an embodiment of the disclosure.

FIG. 5 is an in-use view of an embodiment of the disclosure.

### DETAILED DESCRIPTION OF THE INVENTION

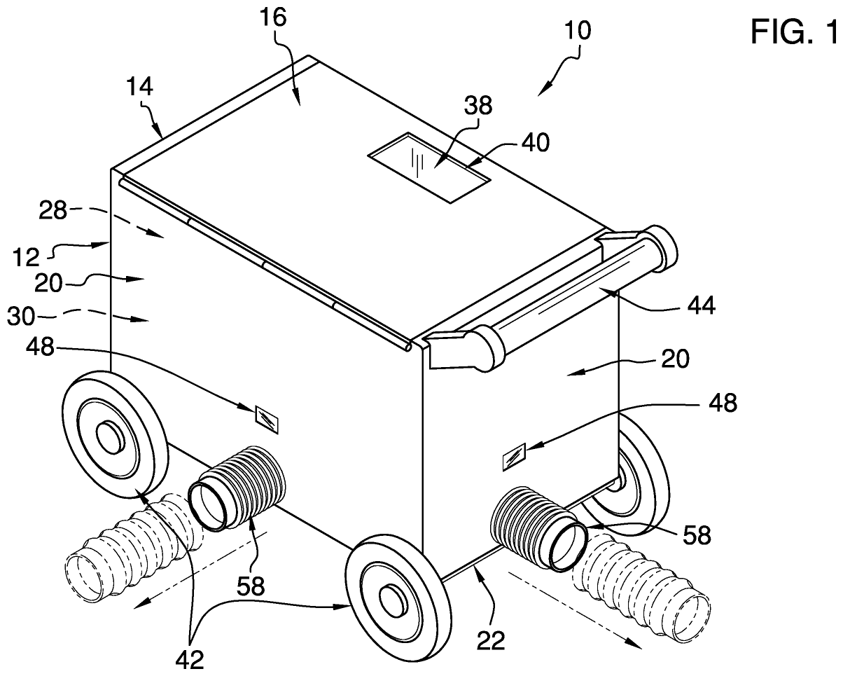

With reference now to the drawings, and in particular to FIGS. 1 through 5 thereof, a new trapping assembly embodying the principles and concepts of an embodiment of the disclosure and generally designated by the reference numeral 10 will be described.

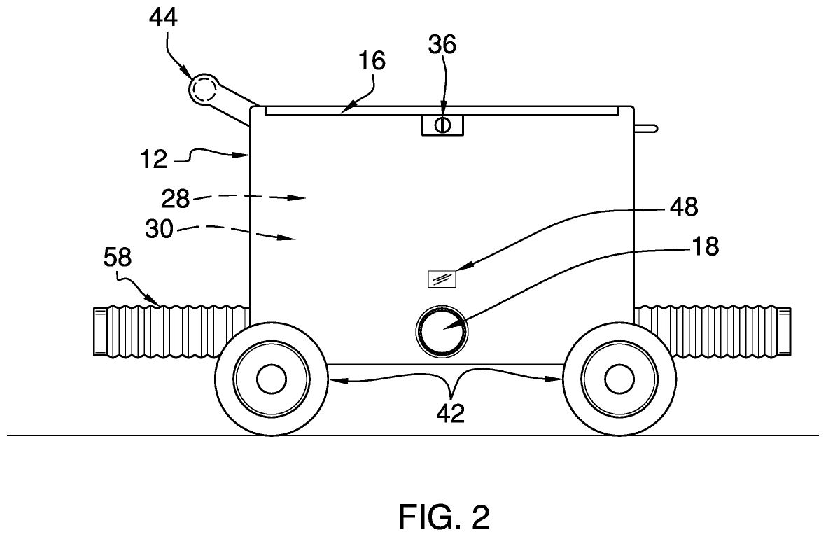

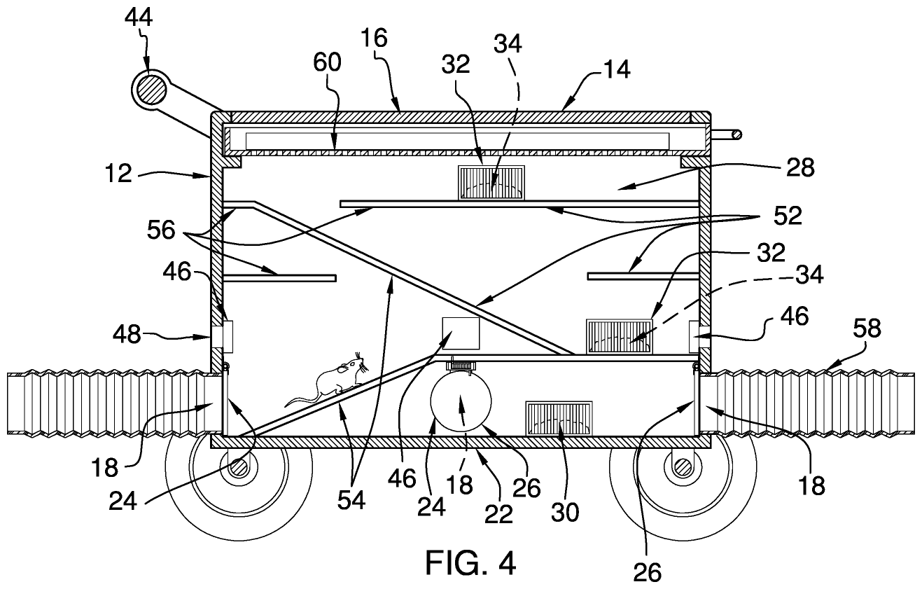

As best illustrated in FIGS. 1 through 5, the nuisance animal trapping assembly 10 generally comprises a box 12, which defines an interior space 28. The box 12 has a top 14, which is open. A lid 16 is hingedly engaged to the box 12 and is positioned to selectively close the top 14. The box 12 has a hole 18 positioned in a side 20 thereof proximate to a bottom 22 thereof. Each side 20 of the box 12 may have a hole 18 positioned therein, as shown in FIGS. 2 and 4.

A closure 24 is engaged to the box 12 proximate to the hole 18 and is configured to selectively close the hole 18, as shown in FIG. 4. The closure 24 comprises a flap 26, which is positioned in the interior space 28 and which is hingedly engaged to the box 12. The flap 26 is spring-loaded. The flap 26 is configured to hinge relative to the box 12 to allow passage of a nuisance animal, such as a rat, into the interior space 28. The flap 26 is configured to rebound to prevent the nuisance animal from exiting the interior space 28 via the hole 18.

A bait station 30 is selectively positionable in the interior space 28 and is configured to attract a nuisance animal through the hole 18 into the interior space 28. The closure 24 is configured to retain the nuisance animal within the interior space 28 to trap the nuisance animal. The bait station 30 may comprise a cage 32 that has an edible bait 34 positioned therein. The cage 32 allows the nuisance animal to smell and possibly nibble on the edible bait 34 but does not allow full access thereto. The present invention also anticipates the bait station 30 comprising other types of bait and attractants, such as pheromones, scents, and the like.

The assembly 10 may comprise a lock unit 36, which is engaged to the lid 16 and which is selectively engageable to the box 12 with the lid 16 in a closed configuration. The lock unit 36 is positioned to lock the lid 16 to the box 12 thus is configured to deter unauthorized access to the interior space 28.

A panel 38 is engaged to the lid 16 and covers an aperture 40 positioned therein. The panel 38 is substantially transparent so that the panel 38 is configured to allow viewing of contents of the box 12.

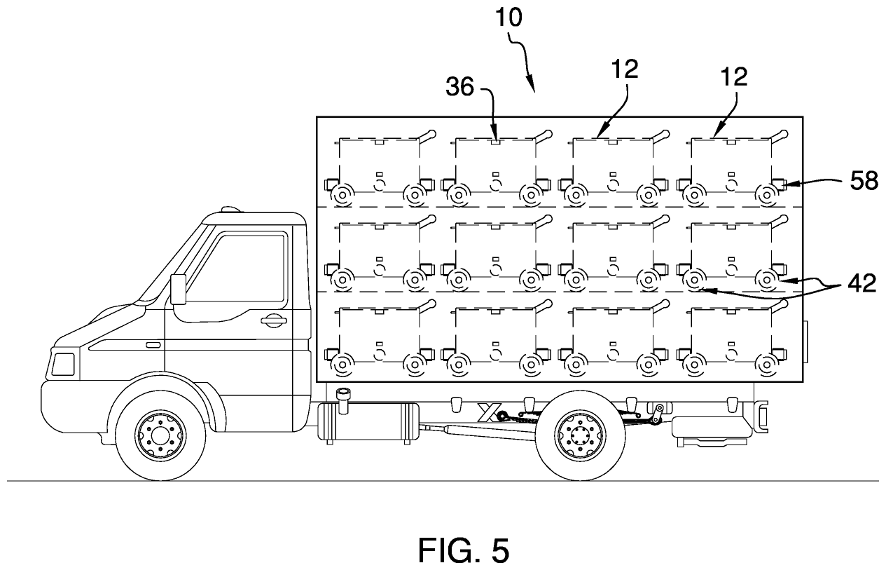

A set of wheels 42 is engaged to the bottom 22 of the box 12 and is configured to allow locomotion of the box 12 upon a surface. A handle 44 is engaged to the box 12 proximate to the top 14 and is configured to be grasped in a hand of a user to manipulate the box 12. The wheels 42 and handle 44 could be utilized, for example, to push the box 12 to a truck and to load the box 12 onto the truck, along with additional boxes 12, as shown in FIG. 5.

A counter 46 is engaged to the box 12 proximate to the hole 18 and is configured to detect entry of the nuisance animal into the interior space 28. The counter 46 is configured to count the nuisance animals entering the interior space 28. A display 48 is coupled to an exterior 50 box 12 and is operationally coupled to the counter 46. The display 48 is configured to present a count of the nuisance animals passing into the interior space 28.

A plurality of plates 52 is coupled to the box 12 and positioned in the interior space 28, defining a set of ramps 54 and a set of ledges 56. Each ramp 54 is configured to be traversed by the nuisance animal so that an associated ledge 56 is reachable by the nuisance animal. Bait stations 30 are selectively positionable on ledges 56 and the bottom 22 of the box 12 to attract nuisance animals to various sites within the interior space 28.

A tube 58 is selectively engageable to the box 12 so that the tube 58 extends from the hole 18. The tube 58 is pleated so that the tube 58 is selectively extensible from the box 12. The tube 58 can be extended from the box 12 to allow the box 12 to trap nuisance animals from a larger area.

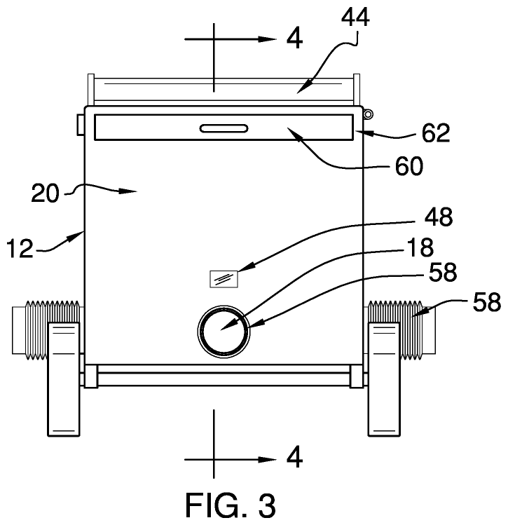

A tray 60 is positioned in the interior space 28 proximate to the top 14. The tray 60 is configured to position a toxic substance, such as dry ice, to euthanize the nuisance animal. Dry ice could be added to the tray 60 by opening the lid 16. Alternatively, as shown in FIGS. 3 and 4, the tray 60 may be slidably engaged to the box 12 and selectively extensible from the box 12 through a slot 62 positioned therein.

In use, the box 12 is positioned in an area frequented by nuisance animals. One or more bait stations 30 are positioned in the interior space 28 to attract the nuisance animals. The tubes 58 can be attached to the box 12 and extended therefrom. As the nuisance animals pass through a tube 58 and push through a flap 26, the flap 26 rebounds to trap the nuisance animals in the box 12. When trapping is concluded, dry ice can be added to the tray 60 to euthanize the nuisance animals.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

I claim:

1. A nuisance animal trapping assembly comprising:
a box defining an interior space, the box having a top, the top being open, the box having a hole positioned in a side thereof proximate to a bottom thereof;
a closure engaged to the box proximate to the hole and being configured for selectively closing the hole;
a lid hingedly engaged to the box and being positioned for selectively closing the top; and
a bait station selectively positionable in the interior space and being configured for attracting a nuisance animal, wherein the bait station is configured for attracting the nuisance animal through the hole, wherein the closure is configured for retaining the nuisance animal within the interior space for trapping the nuisance animal.

2. The nuisance animal trapping assembly of claim 1, wherein each side of the box has a hole positioned therein.

3. The nuisance animal trapping assembly of claim 1, wherein the closure comprises a flap positioned in the interior space and hingedly engaged to the box, the flap being spring-loaded, wherein the flap is configured hinging relative to the box for passing of the nuisance animal into the interior space, and for rebounding for preventing the nuisance animal from exiting the interior space via the hole.

4. The nuisance animal trapping assembly of claim 1, further including a lock unit engaged to the lid and being selectively engageable to the box with the lid in a closed configuration, such that the lock unit is positioned for locking the lid to the box.

5. The nuisance animal trapping assembly of claim 1, further including:
an aperture positioned in the lid; and
a panel engaged to the lid and covering the aperture, the panel being substantially transparent, wherein the panel is configured to allow viewing of contents of the box.

6. The nuisance animal trapping assembly of claim 1, further including a set of wheels engaged to the bottom of the box, wherein the wheels are configured for locomoting the box upon a surface.

7. The nuisance animal trapping assembly of claim 1, further including a handle engaged to the box proximate to the top, wherein the handle is configured for grasping in a hand of a user for manipulating the box.

8. The nuisance animal trapping assembly of claim 1, wherein the bait station comprises a cage having an edible bait positioned therein.

9. The nuisance animal trapping assembly of claim 1, further including:
a counter engaged to the box proximate to the hole and being configured for detecting entry of the nuisance animal into the interior space, wherein the counter is configured for counting the nuisance animals entering the interior space; and
a display coupled to an exterior box and being operationally coupled to the counter, wherein the display is configured for presenting a count of the nuisance animals passing into the interior space.

10. The nuisance animal trapping assembly of claim 1, further including a plurality of plates coupled to the box and positioned in the interior space, such that the plurality of plates defines a set of ramps and a set of ledges, wherein each ramp is configured for traversing by the nuisance animal, such that an associated ledge is reachable by the nuisance animal.

11. The nuisance animal trapping assembly of claim 1, further including a tube selectively engageable to the box such that the tube extends from the hole, the tube being pleated such that the tube is selectively extensible from the box.

12. The nuisance animal trapping assembly of claim 1, further including a tray positioned in the interior space proximate to the top, wherein the tray is configured for positioning a toxic substance for euthanizing the nuisance animal.

13. The nuisance animal trapping assembly of claim 12, wherein the tray being slidably engaged to the box and selectively extensible from the box through a slot positioned therein.

14. A nuisance animal trapping assembly comprising:
a box defining an interior space, the box having a top, the top being open, the box having a hole positioned in a side thereof proximate to a bottom thereof, each side of the box having a hole positioned therein;
a closure engaged to the box proximate to the hole and being configured for selectively closing the hole, the closure comprising a flap positioned in the interior space and hingedly engaged to the box, the flap being spring-loaded, wherein the flap is configured hinging relative to the box for passing of a nuisance animal into the interior space, and for rebounding for preventing the nuisance animal from exiting the interior space via the hole;
a lid hingedly engaged to the box and being positioned for selectively closing the top;
a lock unit engaged to the lid and being selectively engageable to the box with the lid in a closed configuration, such that the lock unit is positioned for locking the lid to the box;
an aperture positioned in the lid;
a panel engaged to the lid and covering the aperture, the panel being substantially transparent, wherein the panel is configured to allow viewing of contents of the box;
a set of wheels engaged to the bottom of the box, wherein the wheels are configured for locomoting the box upon a surface;
a handle engaged to the box proximate to the top, wherein the handle is configured for grasping in a hand of a user for manipulating the box;
a bait station selectively positionable in the interior space and being configured for attracting the nuisance animal, wherein the bait station is configured for attracting the nuisance animal through the hole, wherein the closure is configured for retaining the nuisance animal within the interior space for trapping the nuisance animal, the bait station comprising a cage having an edible bait positioned therein;
a counter engaged to the box proximate to the hole and being configured for detecting entry of the nuisance animal into the interior space, wherein the counter is configured for counting the nuisance animals entering the interior space;
a display coupled to an exterior box and being operationally coupled to the counter, wherein the display is configured for presenting a count of the nuisance animals passing into the interior space;
a plurality of plates coupled to the box and positioned in the interior space, such that the plurality of plates defines a set of ramps and a set of ledges, wherein each ramp is configured for traversing by the nuisance animal, such that an associated ledge is reachable by the nuisance animal;
a tube selectively engageable to the box such that the tube extends from the hole, the tube being pleated such that the tube is selectively extensible from the box; and
a tray positioned in the interior space proximate to the top, wherein the tray is configured for positioning a toxic substance for euthanizing the nuisance animal, the tray being slidably engaged to the box and selectively extensible from the box through a slot positioned therein.
